(19) United States
(12) Patent Application Publication
(10) Pub. No.: US 2023/0306564 A1
(43) Pub. Date: Sep. 28, 2023

(54) System and Methods for Photo In-painting of Unwanted Objects with Auxiliary Photos on Smartphone

(71) Applicant: Huawei Technologies Co., Ltd., Shenzhen (CN)

(72) Inventors: Ning Yan, Addison, TX (US); Masood Seyed Mortazavi, Addison, TX (US)

(21) Appl. No.: 18/328,574

(22) Filed: Jun. 2, 2023

Related U.S. Application Data
(63) Continuation of application No. PCT/US2020/063109, filed on Dec. 3, 2020.

(51) Int. Cl. G06T 5/00; G06T 5/50

(52) U.S. Cl. CPC G06T 5/005; G06T 5/50; G06T 2207/20212

(57) ABSTRACT

A method and network device for correcting photos implemented by an image-capturing device, where the method includes: capturing a primary photo of a target, wherein the primary photo contains an unwanted object; capturing multiple auxiliary photos of a background region behind the target after capturing the primary photo; generating a first transformed auxiliary photo by mapping a first auxiliary photo to the primary photo, wherein the first auxiliary photo is selected from the multiple auxiliary photos; merging the first transformed auxiliary photo with the primary photo to generate a first merged photo in which the unwanted object is partially removed; and in-painting all or part of the unwanted object when the unwanted object is not completely removed from the first merged photo.

### CROSS-REFERENCE TO RELATED APPLICATIONS

This application is a continuation of International Application No. PCT/US2020/063109 filed on Dec. 3, 2020, which is hereby incorporated by reference.

### TECHNICAL FIELD

The present disclosure relates to image in-painting.

### BACKGROUND

Image-capturing devices such as cameras are commonly employed in portable electronic devices such as multimedia players, smart phones, and tablets. Camera capability has become one of the core strengths of smartphones today. The quality of an image taken from a smartphone has generally become better than most pocket cameras mostly due to recently developed computational photography technology.

### SUMMARY

A first aspect relates to method of correcting photos implemented by an image-capturing device. The method includes: capturing a primary photo of a target, where the primary photo contains an unwanted object; capturing multiple auxiliary photos of a background region behind the target after capturing the primary photo; generating a first transformed auxiliary photo by mapping a first auxiliary photo to the primary photo, where the first auxiliary photo is selected from the multiple auxiliary photos; merging the first transformed auxiliary photo with the primary photo to generate a first merged photo in which the unwanted object is partially removed; and in-painting all or part of the unwanted object when the unwanted object is not completely removed from the first merged photo.

Optionally, in any of the preceding aspects, another implementation of the aspect provides that when the unwanted object is not completely removed from the first merged photo before in-painting all or part of the unwanted object, the method further includes: generating a second transformed auxiliary photo by mapping a second auxiliary photo to the primary photo, where the second auxiliary photo is selected from the multiple auxiliary photos; merging the second transformed auxiliary photo with the primary photo to generate a second merged photo in which the unwanted object is at least partially removed; and in-painting all or part of the unwanted object when the unwanted object is not completely removed from the second merged photo.

Optionally, in any of the preceding aspects, another implementation of the aspect provides that capturing the multiple auxiliary photos comprises automatically capturing the multiple auxiliary photos based on a change of positions as a user moves the image-capturing device along a pre-defined path.

Optionally, in any of the preceding aspects, another implementation of the aspect provides that capturing the multiple auxiliary photos comprises simultaneously capturing the multiple auxiliary photos via multiple built-in cameras on the image-capturing device.

Optionally, in any of the preceding aspects, another implementation of the aspect provides that before capturing the multiple auxiliary photos, the method includes: entering a guided in-painting mode after capturing the primary photo; receiving a user selection to remove the unwanted object after entering the guided in-painting mode; and segmenting the primary photo to detect a boundary of the unwanted object.

Optionally, in any of the preceding aspects, another implementation of the aspect provides that the method further includes: masking the boundary of the unwanted object to generate a masked boundary; and mapping the masked boundary to a shooting image plane of the primary photo.

Optionally, in any of the preceding aspects, another implementation of the aspect provides that the method further includes: guiding a user of the image-capturing device to move the image-capturing device to one or more different positions and/or angles; and continuously updating regions of the masked boundary based on changes in the shooting image plane as the user moves the image-capturing device to the one or more different positions and/or angles.

Optionally, in any of the preceding aspects, another implementation of the aspect provides that capturing the multiple auxiliary photos includes: guiding a user of the image-capturing device to move the image-capturing device to one or more different positions and/or angles; and continuously capturing auxiliary photos of the target as the user moves the image-capturing device to the one or more different positions and/or angles until a desired number of the auxiliary photos is reached.

Optionally, in any of the preceding aspects, another implementation of the aspect provides that merging the first transformed auxiliary photo with the primary photo to generate the first merged photo includes using image data from the background region to fill in a region blocked by the unwanted object.

A second aspect relates to a network device for correcting photos. The network device includes a storage device and a processor coupled to the storage device. The processor is configured to execute instructions on the storage device such that when executed, cause the network device to: capture a primary photo of a target, where the primary photo contains an unwanted object; capture multiple auxiliary photos of a background region behind the target after capturing the primary photo; generate a first transformed auxiliary photo by mapping a first auxiliary photo to the primary photo, where the first auxiliary photo is selected from the multiple auxiliary photos; merge the first transformed auxiliary photo with the primary photo to generate a first merged photo in which the unwanted object is partially removed; and in-paint all or part of the unwanted object when the unwanted object is not completely removed from the first merged photo.

Optionally, in any of the preceding aspects, another implementation of the aspect provides that when the unwanted object is not completely removed from the first merged photo before in-painting all or part of the unwanted object, the network device is further configured to: generate a second transformed auxiliary photo by mapping a second auxiliary photo to the primary photo, where the second auxiliary photo is selected from the multiple auxiliary photos; merge the second transformed auxiliary photo with the primary photo to generate a second merged photo in which the unwanted object is at least partially removed; and in-paint all or part of the unwanted object when the unwanted object is not completely removed from the second merged photo.

Optionally, in any of the preceding aspects, another implementation of the aspect provides that the network device is configured to capture the multiple auxiliary photos by automatically capturing the multiple auxiliary photos based on a change of positions as a user moves the network device along a pre-defined path.

Optionally, in any of the preceding aspects, another implementation of the aspect provides that the network device is configured to capture the multiple auxiliary photos by simultaneously capturing the multiple auxiliary photos via multiple built-in cameras on the network device.

Optionally, in any of the preceding aspects, another implementation of the aspect provides that before capturing the multiple auxiliary photos, the network device is further configured to: enter a guided in-painting mode after capturing the primary photo; receive a user selection to remove the unwanted object after entering the guided in-painting mode; and segment the primary photo to detect a boundary of the unwanted object.

Optionally, in any of the preceding aspects, another implementation of the aspect provides that the network device is further configured to: mask the boundary of the unwanted object to generate a masked boundary; and map the masked boundary to a shooting image plane of the primary photo.

Optionally, in any of the preceding aspects, another implementation of the aspect provides that the network device is further configured to: guide a user of the image-capturing device to move the network device to one or more different positions and/or angles; and continuously update regions of the masked boundary based on changes in the shooting image plane as the user moves the network device to the one or more different positions and/or angles.

Optionally, in any of the preceding aspects, another implementation of the aspect provides that the network device is configured to capture the multiple auxiliary photos by: guiding a user of the network device to move the network device to one or more different positions and/or angles; and continuously capturing auxiliary photos of the target as the user moves the network device to the one or more different positions and/or angles until a desired number of the auxiliary photos is reached.

Optionally, in any of the preceding aspects, another implementation of the aspect provides that the network device is configured to merge the first transformed auxiliary photo with the primary photo to generate the first merged photo by using image data from the background region to fill in a region blocked by the unwanted object.

A third aspect relates to a network device for correcting photos. The network device includes: means for capturing a primary photo of a target, where the primary photo contains an unwanted object; means for capturing multiple auxiliary photos of a background region behind the target after capturing the primary photo; means for generating a first transformed auxiliary photo by mapping a first auxiliary photo to the primary photo, where the first auxiliary photo is selected from the multiple auxiliary photos; means for merging the first transformed auxiliary photo with the primary photo to generate a first merged photo in which the unwanted object is partially removed; and means for in-painting all or part of the unwanted object when the unwanted object is not completely removed from the first merged photo.

Optionally, in any of the preceding aspects, another implementation of the aspect provides that the network device further includes: means for guiding a user of the image-capturing device to move the network device to one or more different positions and/or angles; and means for continuously capturing auxiliary photos of the target as the user moves the network device to the one or more different positions and/or angles until a desired number of the auxiliary photos is reached.

Embodiments of the present disclosure aim to enhance the image post-processing capabilities of portable image-capture devices such as that of smartphone cameras. To this end, the disclosed techniques utilize an image segmentation technique to identify object boundaries from multiple photos, as well as photo comparison and merging techniques to find an accurate matching of missing parts after performing object removal. Taking photos from multiple positions and/or using multiple cameras to take multiple photos at the same time provides additional information to fill holes and generate perfect or near-perfect results. Further, one or more in-painting algorithms may be employed on multiple photos to reconstruct missing regions.

For the purpose of clarity, any one of the foregoing implementation forms may be combined with any one or more of the other foregoing implementations to create a new embodiment within the scope of the present disclosure. These embodiments and other features will be more clearly understood from the following detailed description taken in conjunction with the accompanying drawings and claims.

### BRIEF DESCRIPTION OF DRAWINGS

FIG. 1 depicts a photo capturing system according to an embodiment of the disclosure;

FIG. 2 depicts a flowchart of a method according to an embodiment of the disclosure;

FIGS. 3A-3C depict examples of processing photos according to an embodiment of the disclosure;

FIG. 4 is a flowchart depicts another method according to an embodiment of the disclosure;

FIG. 5 is a schematic diagram of a network device according to an embodiment of the disclosure; and

FIG. 6 is a schematic diagram of an apparatus according to embodiments of the disclosure.

### DETAILED DESCRIPTION

With components such as an artificial intelligence (AI)-chip and neural processing unit (NPU) being integrated into a smartphone processor, it becomes more feasible to optimize photos utilizing AI-based photo enhancing algorithms such as in-painting, reflection removal, deburring, de-noising, and the like. When taking high-quality photos using a smartphone, a photo scene might contain some unwanted objects such as electric poles, garbage bins, or simply some people or crowds passing by. Additionally, users commonly experience scenarios of waiting for others passing by just to take a picture without disturbing objects appearing in the picture. However, the presence of unwanted objects is unavoidable in many cases.

Object removal is usually done by professionals in a rather time-consuming process. Alternatively, users may transfer photos from their portable devices to a personal computer (PC) or the like, and then manually perform photo editing using an application such as Adobe Photoshop. However, users may find this option inconvenient and/or time-consuming. Further, while in-paining algorithms may be able to use incomplete information to correct unwanted objects in photos having simple backgrounds and textures, such algorithms do not generate perfect or near-perfect results in photos having backgrounds with complex structures and texture features. Typically, additional information is needed for such purposes.

Disclosed herein are embodiments for allowing end users to quickly remove unwanted objects on a portable device such as a smartphone camera. The disclosed embodiments include a multiple-camera system that captures and optimizes one or more pictures using various photo-processing techniques such as image comparison, image alignment, image stitching, image merging, and the like. After an end user takes a primary photo, the system may automatically take a continuous sequence of multiple auxiliary photos from multiple positions and/or using multiple cameras built into the system. Alternatively, such actions may be manually performed by the end user using a convenient interface. After the end user selects objects to be removed, the system may utilize state-of-the-art image semantic segmentation techniques to identify the boundaries of objects. In turn, the system may utilize homography transformation techniques to transform the auxiliary photos to the same plane of the target photo based on image feature matching techniques such as scale-invariant feature transform (SIFT). The system may also use image segmentation techniques to identify and remove unwanted objects in transformed auxiliary photos. Further still, the system may merge the transformed auxiliary photos with the primary photo by filling any holes with extra information, e.g., state-of-the-art image in-painting algorithms may be used to in-paint remaining holes, if any. The end result is a perfect or near-perfect photo captured by a portable device. These and other features are detailed below.

Overview of Photo Capturing System

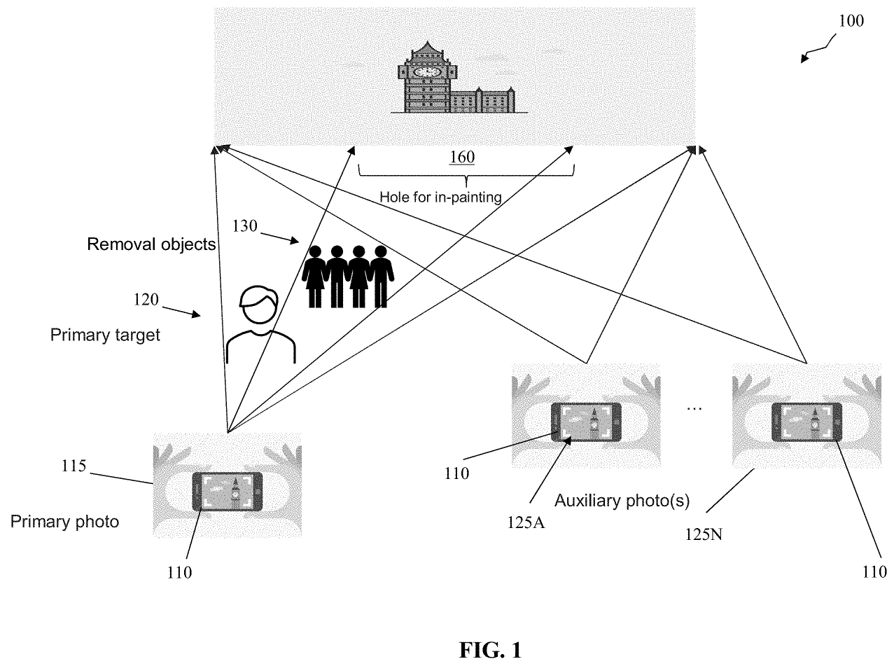

Referring now to FIG. 1, there is depicted a photo capturing system 100 according to an embodiment of the disclosure. The system 100 comprises an image-capturing device 110 for taking a primary photo 115 of a primary target object 120. The image-capturing device 110 may comprise a digital camera, a video camera, video recorder, a still image capture device, a scanning device, a printing device, a smartphone, a tablet, or the like

It is not uncommon for one or more objects to appear between the primary target 120 and a background. In FIG. 1, for example, four individuals appear between the primary target 120 and a building 140 serving as the background in this example. For discussion purposes, these four individuals are designated as removal objects 130 (a.k.a., unwanted objects). As discussed further below, the image-capturing device 110 may be configured to take one or more auxiliary photos 125A, . . . , 125N of the primary target 120 and/or the background including the building 140, where N is a positive integer greater than or equal to one. For discussion purposes, the auxiliary photos 125A, . . . , 125N will be collectively referred to as auxiliary photos 125. In one aspect, the image-capturing device 110 may prompt a user of the device 110 to manually take the auxiliary photos 125 at multiple positions. In another aspect, the image-capturing device 110 may comprise multiple built-in cameras (not shown) configured to take multiple auxiliary photos 125. It should be understood that the built-in cameras may take multiple auxiliary photos 125 in various manners.

As an example, the built-in cameras may take multiple auxiliary photos 125 at the same time as when the image-capturing device 110 takes the primary photo 115. As another example, the built-in cameras may take a continuous sequence of auxiliary photos 125 after the image-capturing device 110 takes the primary photo 115. As yet another example, the built-in cameras may take a sequence of auxiliary photos 125 at intermittent or fixed intervals after the image-capturing device 110 takes the primary photo 115. In these latter two examples, the built-in cameras may automatically take the sequence of auxiliary photos 125, e.g., immediately after the primary photo 115 is taken. Alternatively, the built-in cameras may do so a predefined interval after the image-capturing device 110 takes the primary photo 115.

Overview of System Workflow

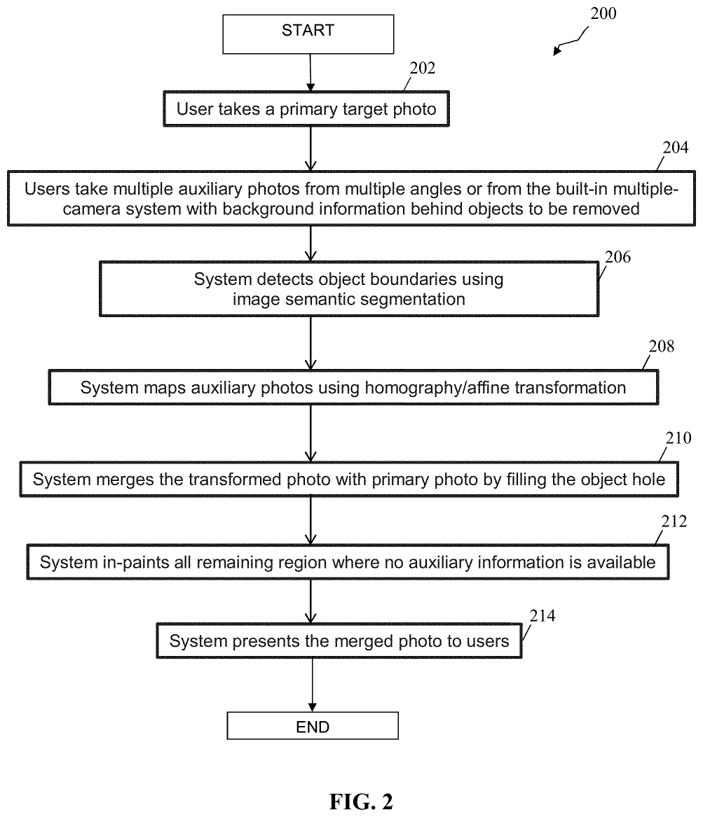

FIG. 2 is a flowchart of a method 200 for operating the system 100 according to an embodiment of the disclosure. The operations in the method 200 may be performed in the order shown, or in a different order. Further, two or more the operations of the method 200 may be performed concurrently instead of sequentially. Note that the following discussion is a general overview of the method 200, and is followed by a more detailed discussion of the individual operations. Also note that while the method 200 may be described using an example where the system 100 performs many of the operations, the method 200 is similarly applicable to examples where the image-capturing device 110 performs those operations.

The method 200 commences at block 202, where a user of the device 110 takes a primary photo 115 of a target object 120, which may contain background information behind unwanted objects to be removed, e.g., removal objects 130. For discussion purposes, assume that the primary photo 115 contains unwanted removal objects 130 that at least partially obscure the building 140 in the background of the primary photo 115. Therefore, at block 204, multiple auxiliary photos 125 may be taken to capture additional image data that may be used to correct such removal objects. For example, multiple auxiliary photos 125 may be taken to capture additional images of the building 140 (with or without the primary target 120 and/or the removal objects 130). In an embodiment, the focus of such additional images may be to capture hidden background areas in the primary photo 110, i.e., areas blocked by the removal objects 130 to be removed.

In one aspect, the user may move the device 110 to capture auxiliary photos 125 from multiple angles and/or at multiple positions. In another aspect, the device 110 may comprise multiple built-in cameras configured to take auxiliary photos 125. In some aspects, the multiple built-in cameras may simultaneously take multiple auxiliary phots 125, e.g., as the primary photo 115 is being taken or a fixed duration after the primary photo 115 is taken. Like the primary photo 115, one or more of the auxiliary photos 125 may contain background information behind unwanted objects to be removed. For example, such background information may contain images of areas including and/or surrounding the building 140.

At block 206, the system 100 may use one or more image segmentation techniques to detect boundaries of objects in the primary photo 115 and auxiliary photos 125. In cases where all or part of the removal objects 130 appear in auxiliary photos 125, the system 100 may perform image segmentation to detect the boundaries of the removal objects 130. Additionally, the system 100 may provide a user of the image-capturing device 110 with an option of selecting unwanted objects to be removed from the auxiliary photos 125. In such cases, object holes may appear in any auxiliary photos 125 from which unwanted objects are to be removed (e.g., removal objects 130).

At block 208, the system 100 may establish a mapping relationship between the auxiliary photos 125 and the primary photo 115. For example, because the auxiliary photos 125 may be captured at multiple different angles and/or locations, information captured in the auxiliary photos 125 may not align with that in the primary photo 115. Therefore, the system 100 may use homography transformation and/or affine transformation to map the auxiliary photos 125 to the same image plane of the primary photo 115, thereby obtaining a transformed auxiliary photo (not shown in FIG. 1).

At block 210, the system 100 may merge the transformed auxiliary photos with the primary photo 115 to at least partially remove unwanted objects. To this end, for example, the system 100 may crop or cut out at least one object hole 160 in the primary photo 115 to remove the removal objects 130, and then employ image matching and comparison techniques to fill any holes in the primary photo 115 with extra auxiliary information (e.g., images/information obtained from the multiple auxiliary photos 125 taken in block 202). If no holes exist after performing the operations in block 210, block 212 may be skipped. However, if some holes still exist and auxiliary information is unavailable after block 210, the system 100 may perform in-painting at block 212 to fill in all remaining holes (missing image content). For example, the system 100 may fill in parts of missing images using a deep learning model (e.g., a neural network) to reconstruct such parts. For example, although auxiliary information may not be available, parts of missing images may be in-painted by borrowing pixels from regions surrounding the missing images. At block 214, the system 100 may present the merged photo to the user, e.g., via a display on the image-capturing device 110.

In-Painting

Image in-painting is a process of reconstructing missing or deteriorated parts of an image in order to present a complete image. This technique may be used to remove unwanted objects from an image or to restore damaged portions of old photos. For example, a patch-based in-painting technique can be used to fill in a missing region patch-by-patch by searching for suitable candidate patches in the undamaged part of an image and copying those patches to corresponding locations. As another example, a diffusion-based in-painting technique can be used to fill in a missing region by propagating image content from the image boundary to the interior of the missing region. In-paining techniques also extend to digital in-painting, which includes the application of algorithms to replace lost or corrupted parts of image data. Such in-painting algorithms can be classified into different categories such as texture synthesis-based image inpainting, Exemplar and search based image inpainting, Partial Differential Equation (PDE) based inpainting, Fast semiautomatic inpainting, hybrid inpainting (in which two or more different in-painting methods are combined), etc.

In-Painting Modes

In an embodiment, the image-capturing device 110 may take multiple auxiliary photos 125 in at least one of two in-painting modes of the disclosures. A first in-painting mode is designated herein as an automatic in-painting mode, where the user moves the image-capturing device 110 through a path while the image-capturing device 110 automatically takes more auxiliary photos 125 from different positions (e.g., using pre-defined shooting settings) to obtain obstructed backgrounds. A second in-painting mode is designated herein as a guided in-paining mode, where the system 100 may guide users to take more auxiliary photos 125 at different angles and/or from different positions to obtain obstructed backgrounds, and where homography transformation may be applied to further obtain a transformed primary photo with obstructed regions being visualized.

Automatic In-Painting Mode

The primary photo 115 may include unwanted objects 130 that a user of the image-capturing device 110 wants to remove. After the primary photo 115 is taken, therefore, the user may be provided with an option to select unwanted objects 130 for removal. In some cases, this option may not be available. For example, the image-capturing device 110 may employ an image segmentation model that cannot provide the user with the correct objects to be removed. In other cases, the user may simply refrain from selecting objects to be removed. For example, the user may not want to do so due to time constraints or due to the quantity of objects to be removed. In such examples where a user does not select objects to be removed after the primary photo 115 is taken, the system 100 may trigger an automatic in-painting mode in which the image-capturing device 110 may automatically take additional photos from different positions.

In the automatic in-painting mode, the system 100 may help the user capture as much of the surrounding environment as possible by following a pre-defined route and/or using predefined shooting settings. For example, the system 100 may prompt the user to move one or more steps in a one or more directions, e.g., left, right, forward, backward, etc. Additionally, the system 100 may prompt the user to orient the image-capturing device 110 at certain angles and/or positions. During this procedure, the image-capturing device 110 may automatically take multiple auxiliary photos 125 based on the change of positions. As previously mentioned, the image-capturing device 110 may take such auxiliary photos 125 continuously as the image-capturing device 110 is moving between positions, or it may do so at a certain time interval, e.g., every second, millisecond, etc.

After a desired number of auxiliary photos 125 are captured, the auxiliary photos 125 may be stored along with the primary photo 115 for future in-painting purposes. For example, the photos 115, 125 may be stored in an internal memory (not shown) of the image-capturing device 110 and/or in an external storage (not shown) accessible to the image-capturing device 100. The system 100 may exit the automatic in-painting mode after storing the photos 115, 125.

Guided In-Painting Mode

The user of the image-capturing device 110 may manually trigger the guided in-painting mode after the primary photo 115 is taken. In turn, the system 100 may provide the user with an option of selecting a primary object and one or more other objects to be removed. For example, these objects may be the removal objects 130 behind the primary target 120 in FIG. 1.

After the guided in-painting mode begins, the system 100 may guide the user to take one or more auxiliary photos 125 from different locations and/or orientations. For example, based on the removal objects 130 selected by the user, the system 100 may identify optimal locations and/or orientations so as to obtain auxiliary photos 125 that provide useful information for in-painting the removal objects 130. Although multiple auxiliary photos 125 may be acquired, one or more of these auxiliary photos 125 may still contain some unwanted objects. Therefore, the system 100 may again provide the user with an option of selecting unwanted objects (not shown in FIG. 1) in the one or more auxiliary photos 125.

In the in-guided painting mode, the system 100 may perform image object/semantic segmentation using one or more machine learning/neural network models to detect object boundaries and identify holes or regions to be removed from the primary photo 110. For example, using a suitable segmentation model such as DeepLabv3, which was designed and open-sourced by Google®, a subsidiary of Alphabet, Inc., the system 100 can identify certain mask region boundaries of the objects to be removed. An object boundary indicates a background region of unwanted objects (e.g., removal objects 130). Additionally, the shape of an object boundary may change according to movement of the shooting image plane. The system 100 may draw the mask region boundaries over the shooting preview images of the image-capturing device 110.

In an embodiment, the system 100 may utilize an image transformation technique to transform auxiliary photos 125 taken at different angles/positions to the same image plane of the primary photo 115. For example, the system 100 may do this using homography transformation based on an image feature masking technique such as SIFT. That is, SIFT or another suitable technique may be used to map or establish a relationship between the auxiliary photos 125 and the primary photo 115. This way, the mask region boundaries may be mapped to the shooting preview image plane using homography transformation based on the image feature masking technique between the primary photo 115 and the preview images obtained. For example, when capturing auxiliary images, a user may want to identify background regions that are obstructed by unwanted objects. The system 100 may be configured to display such information in the shooting preview of auxiliary photos 125. The mask region boundaries may be continuously updated with the changes in the shooting image plane as the user moves the image-capturing device 110 around, e.g., per guidance from the system 100. The user may push a shooting button of the image-capturing device 110 when the user ascertains that one of the mask regions is full or almost full and when the background contains the desired information. The user may do this iteratively until all of the mask regions are fully covered, at which point the system 100 may exit the guided in-painting shooting mode.

Deep Learning Algorithms & Imaging Techniques

In an embodiment, the system 100 and/or the image-capturing device 110 may employ one or more deep algorithms and/or one or more imaging techniques to detect object boundaries and determine image backgrounds. Such techniques may include semantic image segmentation, instance segmentation, object detection, imagine classification, image transformation, image merging, image matching, feature extraction, and the like. In one aspect, for example, a semantic segmentation technique such as DeepLabV3 may be employed to extract information from an image and use the extracted information to reconstruct the image, e.g., without unwanted objects such as removal objects 130.

Example of Imaging Techniques

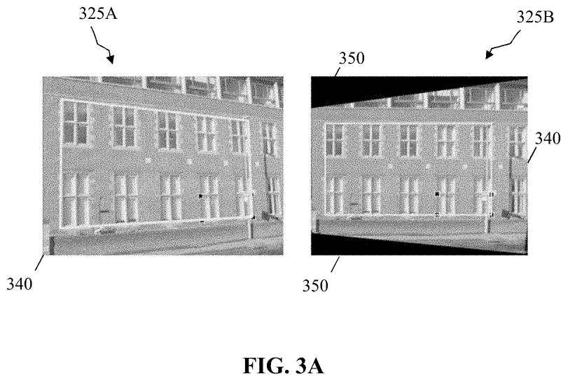

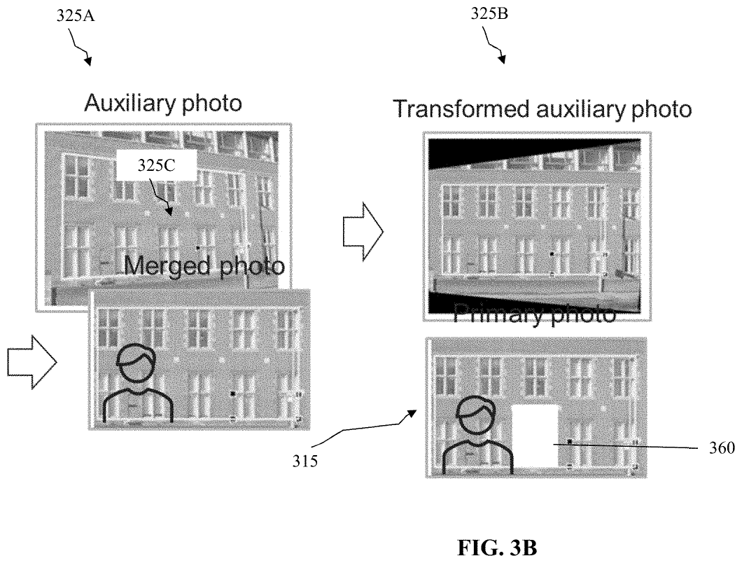

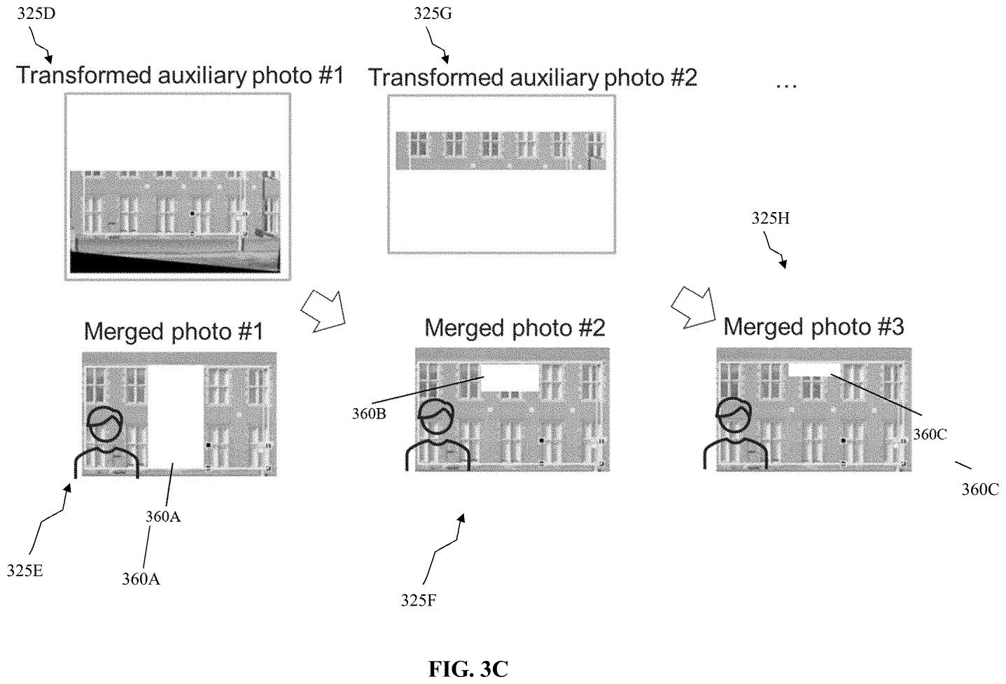

FIGS. 3A-3C depict examples of performing various imaging techniques according to embodiments of the disclosure. For discussion purposes, assume that the system 100 and/or image-capturing device 110 perform these functions on the primary photo 115 and auxiliary photos 125 in FIG. 1. Thus, the building 140 in the background of the primary target 120 in FIG. 1 is assumed to be the building 340 shown in FIGS. 3A-3C, and one of the auxiliary photos 125A . . . , 125N is assumed to be the auxiliary photo 325A shown in FIGS. 3A-3C.

In an embodiment, the system 100 and/or image-capturing device 110 may use image transformation such as homography transformation or affine transformation to map auxiliary photos 125 to a target photo plane, e.g., based on a feature matching algorithm such as SIFT. That is, a transformation technique may be used to map images in auxiliary photos 125 captured at different angles and/or positions to the same image plane of the primary photo 115. For example, it can be seen from FIG. 3A that the image of the building 340 in the auxiliary photo 325A is obtained at a skewed angle.

Therefore, the system 100 and/or image-capturing device 110 may use image transformation to map the image of the building 340 in the auxiliary photo 325A to a preferred angle. The example in FIG. 3A is based on the system 100 using homography transformation to generate a transformed auxiliary photo 325B, where it can be seen that the building 340 no longer appears at a skewed angle after the auxiliary photo 325A is transformed. However, it can also be seen that the size of the building 340 in the transformed auxiliary photo 325B has been reduced. As a result, the transformed auxiliary photo 325B may include some blackened areas 350 that may be removed as part of the editing process.

It should be understood that while the example in FIG. 3A is based on using homography transformation, affine transformation or other similar techniques may be used in other examples. Additionally, the system 100 and/or image-capturing device 110 may employ feature extracting and image matching techniques such as SIFT to extract, detect, and describe features in images captured in the primary photo 115 and auxiliary photos 125.

In an embodiment, the system 100 and/or image-capturing device 110 may merge an image based on feature matching techniques. For discussion purposes, assume that the primary photo 115 in FIG. 1 includes an unwanted region to be removed, e.g., via user-selection or objection boundary detection. FIG. 3B, for example, depicts a primary photo 315 containing an object hole 360 to be removed or corrected. For discussion purposes, assume that the primary photo 315 is the primary photo 115 captured in FIG. 1.

As shown in FIG. 3B, the system 100 and/or image-capturing device 110 may merge the transformed auxiliary photo 325B with a primary photo 315 to generate a corrected photo. For example, the system 100 may employ image comparison and feature matching techniques to merge the transformed auxiliary photo 325B with the primary photo 315, thereby filling the object hole 360 to generate a merged photo 325C having a corrected background as shown.

In some cases, the system 100 and/or image-capturing device 110 may not be able to remove the object hole 360 in a single operation. In such cases, additional operations may be performed to remove the object hole 360. As discussed further with respect to FIG. 3C, if multiple auxiliary photos are available, the system 100 and/or image-capturing device 110 may merge one or more of the auxiliary photos with a primary photo by filling the unwanted object hole 360 with additional information extracted from the multiple auxiliary photos. Additionally, when unwanted objects appear in auxiliary photos, the system 100 and/or image-capturing device 110 may detect boundaries of the unwanted objects. In some aspects, users may be provided with an option to select unwanted objects for removal, but some holes may still remain in the auxiliary photos.

In the example depicted in FIG. 3C, assume a first auxiliary photo (not shown) is available that is similar to the auxiliary photo 325A in FIG. 3B, except the first auxiliary photo contains an unwanted object such as the object hole 360 in the primary photo 315. As a result of this unwanted object, further assume the following: a first transformed auxiliary photo 325D is generated after the first auxiliary photo is merged with the primary photo 315; and a first merged photo 325E is generated after the first transformed auxiliary photo 325D is merged with the primary photo 315.

In an embodiment, the system 100 and/or image-capturing device 110 may merge multiple auxiliary photos in an order that can minimize the size of unfilled regions such as the object hole 360. As shown in FIG. 3C, the first merged photo 325E contains an object hole 360A. Therefore, the system 100 and/or image-capturing device 110 may merge the first transformed auxiliary photo 325D with the first merged photo 325E to generate a second merged photo 325F. However, the second merged photo 325F still contains part 360B of the object hole 360A. That is, the first auxiliary photo may not have provided enough information to completely remove the object hole 360B.

As a result, the system 100 and/or image-capturing device 110 may select a second auxiliary photo (not shown) from the multiple auxiliary photos to correct the object hole 360B in the second merged photo 360F. Again, this selection may be based on an order that minimizes the size of unfilled regions, such as the object hole 360B in this case. The system 100 and/or image-capturing device 110 may first merge the second auxiliary photo with the primary photo 315 to generate a second transformed auxiliary photo 325G. The system 100 and/or image-capturing device 110 may then merge the second transformed auxiliary photo 325G with the second merged photo 320F to generate a third merged photo 325H. It can be seen from FIG. 3C that the third merged photo 325H still contains a part 360C of the object hole 360B.

In an embodiment, the system 100 and/or image-capturing device 110 may iteratively perform the aforementioned operations until the object hole 360C is completely removed. In some cases, however, part of the object hole 360C may still remain after the auxiliary photos have been exhausted. That is, no additional information may be available to compensate for the missing part of the object hole 360C.

In such cases, the system 100 and/or image-capturing device 110 may employ an in-painting algorithm to fill any remaining part of the object hole 360C. As can be seen from FIG. 3C, the size of the object hole 360C is relatively small at this point of the process. Therefore, a variety of in-painting techniques may be employed to remove the object hole 360C (i.e., complex and intensive reconstruction techniques are likely not necessary). For example, such in-painting techniques may include neural network (NN)-based image in-painting approaches, convolutional NN (CNN) approaches, deep machine-learning approaches, diffusion-based approaches, sparse representation of images, exemplar-based approaches, and the like.

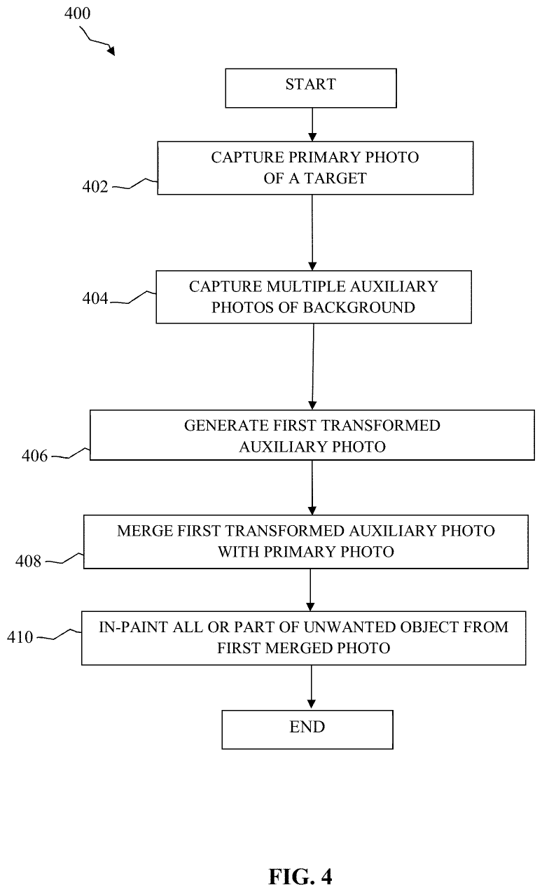

FIG. 4 depicts a flowchart of a method 400 of in-painting unwanted objects according to an embodiment of the disclosure. The operations in the method 400 may be performed in the order shown, or in a different order. Further, two or more the operations of the method 400 may be performed concurrently instead of sequentially.

At block 402, the method comprises capturing a primary photo of a target, where the primary photo contains an unwanted object. At block 404, the method 400 comprises capturing multiple auxiliary photos of a background region behind the target after capturing the primary photo. As previously discussed, the background region may contain images of regions in the primary photo that are blocked by the unwanted object. At block 406, the method 400 comprises generating a first transformed auxiliary photo. For example, the first transformed auxiliary photo may be generated by mapping a first auxiliary photo to the primary photo, where the first auxiliary photo is selected from the multiple auxiliary photos. At block 408, the method 400 comprises merging the first transformed auxiliary photo with the primary photo to generate a first merged photo in which the unwanted object is partially removed. To this end, for example, the method 400 may utilize image data indicative of the background region to fill in regions/holes blocked by the unwanted object. At block 410, the method 400 may in-paint all or part of the unwanted object when the unwanted object is not completely removed from the first merged after carrying out block 408.

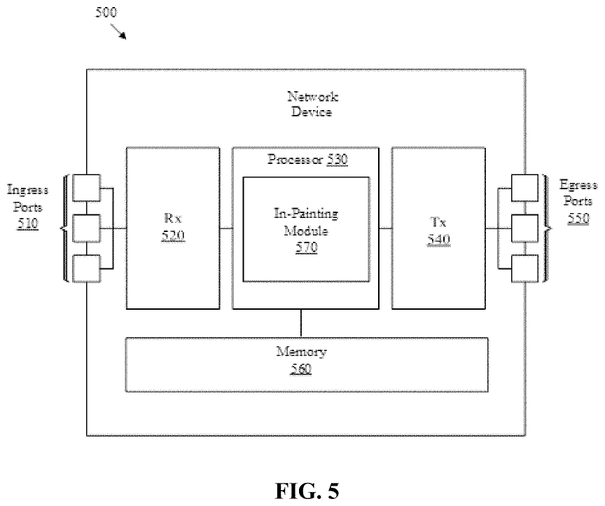

FIG. 5 is a schematic diagram of a network device 500 according to an embodiment of the disclosure. The network device 500 is suitable for implementing the components described herein. The network device 500 comprises ingress ports 510 and receiver units (Rx) 520 for receiving data; a processor, logic unit, or central processing unit (CPU) 530 to process the data; transmitter units (Tx) 540 and egress ports 550 for transmitting the data; and a memory 560 for storing the data. The network device 500 may also comprise optical-to-electrical (OE) components and electrical-to-optical (EO) components coupled to the ingress ports 510, the receiver units 520, the transmitter units 540, and the egress ports 550 for egress or ingress of optical or electrical signals.

In some embodiments, the network device 500 may connect to one or more bidirectional links. Additionally, the receiver units 520 and transmitter units 540 may be replaced with one or more transceiver units at each side of the network device 500. Similarly, the ingress ports 510 and egress ports 550 may be replaced with one or more combinations of ingress/egress ports at each side of the network device 500. As such, the transceiver units 520 and 540 may be configured to transmit and receive data over one or more bidirectional links via ports 510 and 550.

The processor 530 may be implemented by hardware and software. The processor 530 may be implemented as one or more CPU chips, cores (e.g., as a multi-core processor), field-programmable gate arrays (FPGAs), application specific integrated circuits (ASICs), and digital signal processors (DSPs). The processor 530 may be in communication with the ingress ports 510, receiver units 520, transmitter units 540, egress ports 550, and memory 560. The processor 530 comprises an in-painting module 570. The module 570 may implement the disclosed embodiments described above. For instance, the module 570 may implement the method 200 of FIG. 2, the method 400 of FIG. 4, and processes disclosed herein. The inclusion of the module 570 therefore provides a substantial improvement to the functionality of the device 500 and effects a transformation of the device 500 to a different state. Alternatively, the module 570 may be implemented as instructions stored in the memory 560 and executed by the processor 530.

The memory 560 comprises one or more disks, tape drives, and solid-state drives and may be used as an over-flow data storage device, to store programs when such programs are selected for execution, and to store instructions and data that are read during program execution. The memory 560 may be volatile and non-volatile and may be read-only memory (ROM), random-access memory (RAM), ternary content-addressable memory (TCAM), and static random-access memory (SRAM).

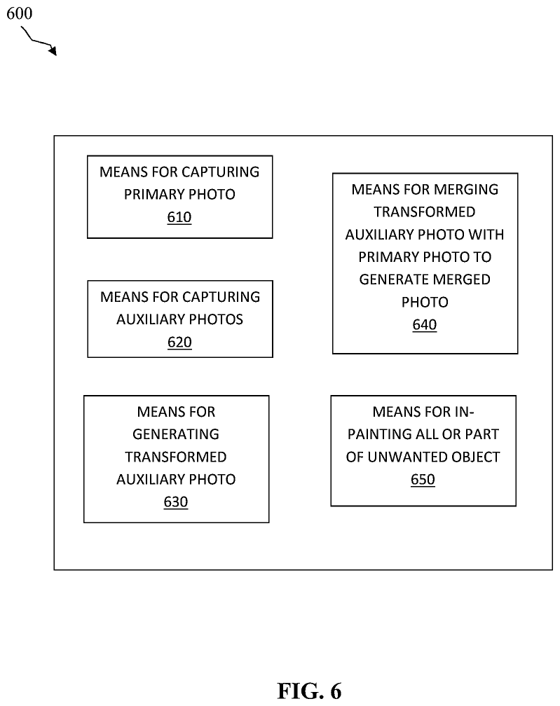

FIG. 6 is a schematic diagram of an apparatus 600 for correcting photos according to various embodiments of the disclosure. The apparatus 600 may comprise: means 610 for capturing a primary photo of a target, where the primary photo contains an unwanted object; means 620 capturing multiple auxiliary photos of a background region behind the target after capturing the primary photo; means 630 for generating a first transformed auxiliary photo; means 640 for merging the first transformed auxiliary photo with the primary photo to generate a first merged photo in which the unwanted object is partially removed; and means 650 for in-painting all or part of the unwanted object when the unwanted object is not completely removed from the first merged.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A method for correcting photos implemented by an image-capturing device, comprising:
capturing a primary photo of a target;
identifying an unwanted object within the primary photo of the target;
capturing multiple auxiliary photos of a background region behind the target after capturing the primary photo;
generating a first transformed auxiliary photo by mapping a first auxiliary photo of the multiple auxiliary photos to the primary photo;
merging the first transformed auxiliary photo with the primary photo to generate a first merged photo in which the unwanted object is at least partially removed; and
in-painting all or part of the unwanted object when the unwanted object is not completely removed from the first merged photo.

2. The method of claim 1, wherein when the unwanted object is not completely removed from the first merged photo before in-painting all or part of the unwanted object, the method further comprises:
generating a second transformed auxiliary photo by mapping a second auxiliary photo to the primary photo, wherein the second auxiliary photo is selected from the multiple auxiliary photos;
merging the second transformed auxiliary photo with the primary photo to generate a second merged photo in which the unwanted object is at least partially removed; and
in-painting all or part of the unwanted object when the unwanted object is not completely removed from the second merged photo.

3. The method of claim 1, wherein capturing the multiple auxiliary photos comprises automatically capturing the multiple auxiliary photos based on a change of positions as a user moves the image-capturing device along a pre-defined path.

4. The method of claim 1, wherein capturing the multiple auxiliary photos comprises simultaneously capturing the multiple auxiliary photos via multiple built-in cameras on the image-capturing device.

5. The method of claim 1, wherein before capturing the multiple auxiliary photos, the method comprises:
entering a guided in-painting mode after capturing the primary photo;
receiving a user selection to remove the unwanted object after entering the guided in-painting mode; and
segmenting the primary photo to detect a boundary of the unwanted object.

6. The method of claim 5, further comprising:
masking the boundary of the unwanted object to generate a masked boundary; and
mapping the masked boundary to a shooting image plane of the primary photo.

7. The method of claim 6, further comprising:
guiding a user of the image-capturing device to move the image-capturing device to one or more different positions and/or angles; and
continuously updating regions of the masked boundary based on changes in the shooting image plane as the user moves the image-capturing device to the one or more different positions and/or angles.

8. The method of claim 1, wherein capturing the multiple auxiliary photos comprises:
guiding a user of the image-capturing device to move the image-capturing device to one or more different positions and/or angles; and
continuously capturing auxiliary photos of the target as the user moves the image-capturing device to the one or more different positions and/or angles until a desired number of the auxiliary photos is reached.

9. The method of claim 1, wherein merging the first transformed auxiliary photo with the primary photo to generate the first merged photo comprises using image data from the background region to fill in a region blocked by the unwanted object.

10. A network device, comprising:
a memory including instructions; and
one or more processors coupled to the memory, the one or more processors configured to execute the instructions to cause the network device to:
capture a primary photo of a target;
identify an unwanted object within the primary photo of the target
capture multiple auxiliary photos of a background region behind the target after capturing the primary photo;
generate a first transformed auxiliary photo by mapping a first auxiliary photo of the multiple auxiliary photos to the primary photo;
merge the first transformed auxiliary photo with the primary photo to generate a first merged photo in which the unwanted object is partially removed; and
in-paint all or part of the unwanted object when the unwanted object is not completely removed from the first merged photo.

11. The network device of claim 10, wherein when the unwanted object is not completely removed from the first merged photo before in-painting all or part of the unwanted object, the network device is further configured to:
generate a second transformed auxiliary photo by mapping a second auxiliary photo to the primary photo, wherein the second auxiliary photo is selected from the multiple auxiliary photos;
merge the second transformed auxiliary photo with the primary photo to generate a second merged photo in which the unwanted object is at least partially removed; and
in-paint all or part of the unwanted object when the unwanted object is not completely removed from the second merged photo.

12. The network device of claim 10, wherein the network device is configured to capture the multiple auxiliary photos by automatically capturing the multiple auxiliary photos based on a change of positions as a user moves the network device along a pre-defined path.

13. The network device of claim 10, wherein the network device is configured to capture the multiple auxiliary photos by simultaneously capturing the multiple auxiliary photos via multiple built-in cameras on the network device.

14. The network device of claim 10, wherein before capturing the multiple auxiliary photos, the network device is further configured to:
enter a guided in-painting mode after capturing the primary photo;
receive a user selection to remove the unwanted object after entering the guided in-painting mode; and
segment the primary photo to detect a boundary of the unwanted object.

15. The network device of claim 14, wherein the network device is further configured to:
mask the boundary of the unwanted object to generate a masked boundary; and
map the masked boundary to a shooting image plane of the primary photo.

16. The network device of claim 15, wherein the network device is further configured to:
guide a user of the network device to move the network device to one or more different positions and/or angles; and
continuously update regions of the masked boundary based on changes in the shooting image plane as the user moves the network device to the one or more different positions and/or angles.

17. The network device of claim 10, wherein the network device is configured to capture the multiple auxiliary photos by:
guiding a user of the network device to move the network device to one or more different positions and/or angles; and
continuously capturing auxiliary photos of the target as the user moves the network device to the one or more different positions and/or angles until a desired number of the auxiliary photos is reached.

18. The network device of claim 10, wherein the network device is configured to merge the first transformed auxiliary photo with the primary photo to generate the first merged photo by using image data from the background region to fill in a region blocked by the unwanted object.
